(19) United States
(12) Patent Application Publication
(10) Pub. No.: US 2007/0281630 A1
(43) Pub. Date: Dec. 6, 2007

(54) Apparatus for vocal communication over computer networks

(76) Inventor: Shii-Jer Chang, Taipei (TW)

Correspondence Address: TROXELL LAW OFFICE PLLC;SUITE 1404, 5205 LEESBURG PIKE, FALLS CHURCH, VA, 22041, US

(21) Appl. No.: 11/635,528

(22) Filed: Dec. 8, 2006

(30) Foreign Application Priority Data
Jun. 5, 2006 (TW) 095209686

(51) Int. Cl. H04B 1/38

(52) U.S. Cl. 455/90.2

(57) ABSTRACT

The invention proposes an apparatus for vocal communication over computer networks comprising a speaker, a microphone, and network connection. It should be noted that the apparatus has a USB connector, an audio connector, as well as a microphone connector, and its connection to the computer is not through a single USB connector, so as to allow the apparatus to achieve vocal communication without the need for an integrated audio circuit or chip.

### CROSS-REFERENCES TO RELATED APPLICATIONS

Not Applicable

### STATEMENT REGARDING FEDERALLY SPONSORED RESEARCH OR DEVELOPMENT

Not Applicable

### DESCRIPTION

1. Field of the Invention

The invention relates to an apparatus for vocal communication over computer networks, and more particularly, to an apparatus with a built-in USB connector, an audio connector, and a microphone connector for vocal communication without the need for integrated audio circuit or chip.

2. Background of the Invention

The Internet has greatly shortened the distance to any given place around the world, as a result, the communication and exchanges between one place and the other one can be readily accomplished. The exchanges encompass information such as words and pictures, which are displayed on screens, whereas the communication includes vocal communication, which is essentially conversation between two parties where both sides express their intentions.

Therefore, the latest apparatus for communication over computer networks are built with the basic USB (Universal Serial Bus) connection system, the audio component like earphones, and the sound-pickup component like microphones to allow for communication.

However, in the general apparatus for communication over computer networks, it is common to combine the USB connection system, the audio component, and the sound-pickup component into the USB connection system. The advantage of this method is that several connectors of the apparatus are merged into a single USB connector; in other words, the apparatus can allow for vocal communication between two places over computer networks via its single USB connection with the computer.

Although the merging of several connectors into a single USB connector in the apparatus for vocal communication simplifies the structure of the apparatus and is convenient to use, it requires having a complicated integrated audio circuit or chip soldered on the circuit board of the apparatus in order to obtain the advantage mentioned above. Because of this reason, the production of the apparatus becomes costly and the circuit of the apparatus becomes structurally complicated.

In light of such problems, the invention seeks to propose an effective solution, which divides the audio component, the sound-pickup component, and the network connection component of the apparatus into individual USB connector, audio connector, and microphone connector. By connecting the individual connectors to the corresponding jacks in the computer, the apparatus can achieve vocal communication without the need of an integrated audio circuit or chip

### SUMMARY OF THE INVENTION

As the Internet becomes more and more popular, the delivery of information and expression of messages also become more rapid and more readily accomplished. Therefore, instant messaging software and products related to network videoconferencing are developed and put to use, and the use of instant messaging software is especially popular among the users of the Internet.

In order to allow vocal communication over computer networks, the apparatus developed for such purpose must at least include the USB connection system, the audio component like earphones, and sound-pickup components like microphones to fulfill the purpose. In the general apparatus for vocal communication over computer networks, it is common to combine the USB connection system that connects to computers, the audio connector, and the sound-pickup component into the USB connection system for ease of use, but this method must rely on a complicated integrated audio circuit to achieve communication.

The apparatus of the invention is also built with an USB connection system, an audio component, and a sound-pickup component; the end of the signal transmit line is divided into an USB connector, an audio connector, and a microphone connector that can be connected to the computer separately, so that the apparatus can allow for vocal communication without the need of integrated audio circuit or chip.

The foregoing aspects, as well as many of the attendant advantages and features of this invention will become more apparent by reference to the following detailed description, when taken in conjunction with the accompanying drawings.

### BRIEF DESCRIPTION OF THE DRAWINGS

FIG. 1 is a three-dimensional view of the apparatus of the invention.

FIG. 2 is a dissected view showing the main part of the apparatus of the invention.

FIG. 3 is a three-dimensional view showing the embodiment for the apparatus of the invention.

### DETAILED DESCRIPTION OF SOME EMBODIMENTS

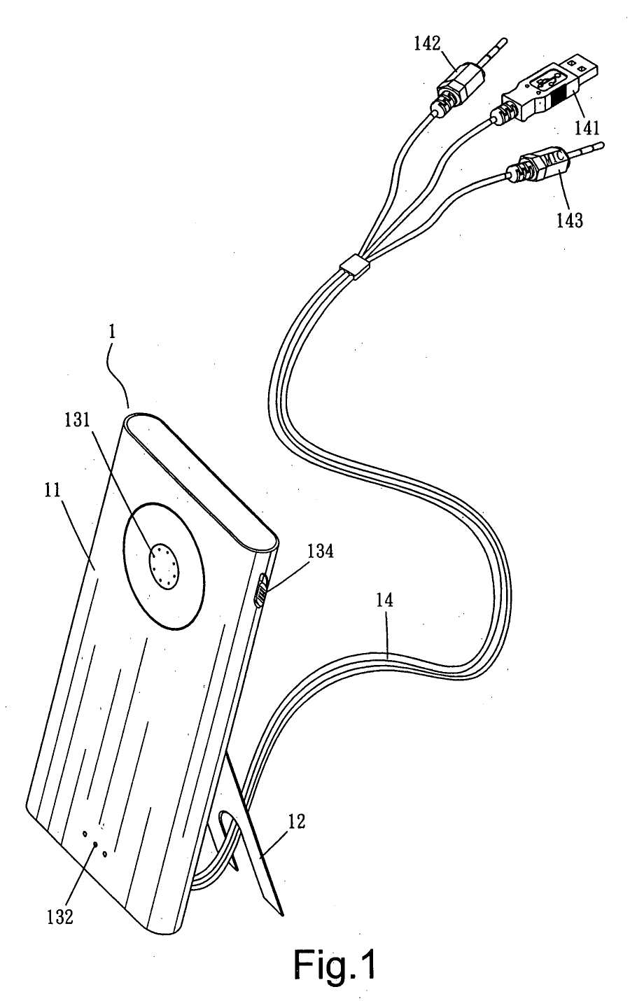

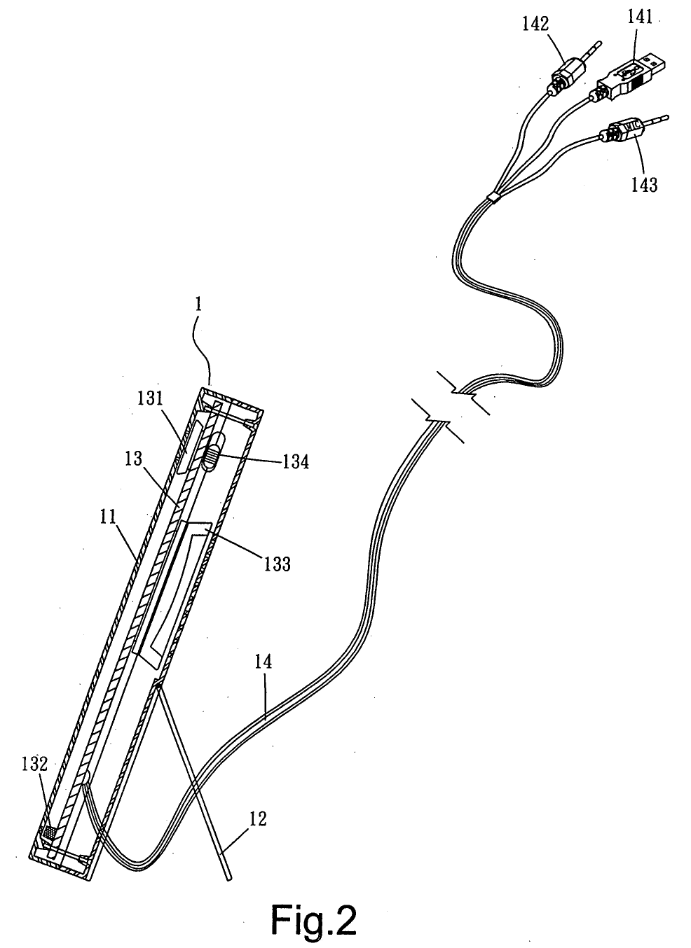

As shown in FIGS. 1 and 2, the apparatus 1 for vocal communication over computer networks disclosed in the invention comprises a case 11, a support 12, a circuit board 13, and a signal transmit line 14.

The circuit board 13 has an audio speaker 131 functioning as an earphone and a sound-pickup component 132 functioning as a microphone disposed on one of its surfaces; the position of said audio speaker 131 and sound-pickup component 132 corresponds to the position of the ears and the mouth while wearing.

The circuit board 13 has a hold-free speaker 133 as of general telephones or cellular phones and a hold-free speaker switch 134 disposed on its other surface; said hold-free speaker 133 is disposed on the surface other than the one with the sound-pickup component 132 to prevent the sound transmitted from the hold-free speaker being picked up by the sound-pickup component and generating noise.

To use the hold-free speaker in the apparatus of the invention, simply swivel around the support 12 on said case 11 and switch on the hold-free speaker switch 134, and thus allowing the apparatus to stand on a flat surface and be used without holding it.

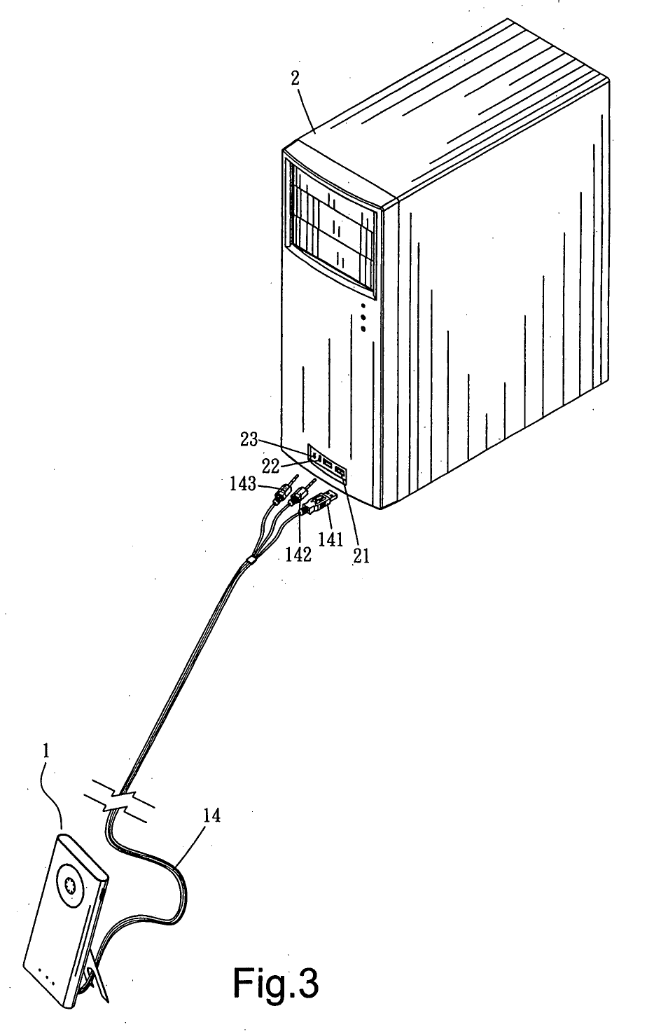

As indicated in FIG. 3, the signal transmit line 14 extends from the circuit board 13 to beyond the case 11 and has an USB connector 141, an audio connector 142, and a microphone connector 143 at its end; said USB connector 141, audio connector 142, and microphone connector 143 can be connected to an USB jack 21, an audio jack 22, and a microphone jack 23 in a computer 2, respectively, so that the apparatus disclosed in the invention allows for vocal communication without the need of an integrated audio circuit or chip

While the invention has been particularly shown and described with reference to the preferred embodiments thereof, these are, of course, merely examples to help clarify the invention and are not intended to limit the invention. It will be understood by those skilled in the art that various changes, modifications, and alterations in form and details may be made therein without departing from the spirit and scope of the invention, as set forth in the following claims.

What is claimed is:

1. An apparatus for vocal communication over computer networks, comprising a case 11, a support 12, a circuit board 13, and a signal transmit line 14; said circuit board 13 having an audio speaker 131 and a sound-pickup component 132 disposed on one of its surfaces; said signal transmit line 14 extending from said circuit board 13 to beyond the case 11 having a USB connector 141, an audio connector 142, and a microphone connector 143 on its end; said USB connector 141, audio connector 142, and microphone connector 143 being connectable to an USB jack 21, an audio jack 22, and a microphone jack 23 of a computer 2, respectively, so that the apparatus disclosed in the invention allows for vocal communication without the need of an integrated audio circuit or chip.

2. The apparatus for vocal communication over computer networks cited in claim 1, wherein said circuit board 13 having a hold-free speaker 133 as used for general telephones or cellular phones and a hold-free speaker switch 134 disposed on the other surface, the support 12 mounted on said case 11 being pivotally movable and the hold-free speaker switch 134 being switchable, and thus allowing the apparatus to stand on a flat surface and serve as a hold-free speaker.
